(19) United States
(12) Patent Application Publication
(10) Pub. No.: US 2005/0059382 A1
(43) Pub. Date: Mar. 17, 2005

(54) Method and a system for submitting a message deposited in an in-box of a messaging service

(76) Inventors: Arnaud Brun, Boulogne Billancourt (FR); Aline Potier, Antony (FR); Clery Tonneau, Meudon (FR)

Correspondence Address: YOUNG & THOMPSON, 745 SOUTH 23RD STREET, 2ND FLOOR, ARLINGTON, VA, 22202, US

(21) Appl. No.: 10/896,860

(22) Filed: Jul. 23, 2004

(30) Foreign Application Priority Data
Jul. 24, 2003 (EP) 03291836.9

(51) Int. Cl. H04Q 7/20

(52) U.S. Cl. 455/412.1; 455/412.2

(57) ABSTRACT

A method of submitting a message (MSG) to a telecommunications terminal (3) of a destination user, which message has been deposited by a sender user in an in-box (4) hosted by a messaging server (1), with submission taking place via a telecommunications network (2), and the method consisting at least in:
transmitting the message (MSG) from the destination user's in-box (4) to a multimedia messaging server (MMSC); and
transmitting a multimedia message (MMS) from the multimedia messaging server (MMSC) to the terminal (3) of said destination user, the multimedia message containing at least said deposited message, thereby enabling said destination user to have the deposited message directly available on said user's own communications terminal.

The present invention relates to a system for submitting a message to a telecommunications terminal, which message has been deposited in an in-box of a messaging service, and the invention also relates to a submission method associated with the system.

### BACKGROUND OF THE INVENTION

In the field of telecommunications, messaging services are very widespread.

In particular, the multimedia messaging service (MMS) enables multimedia messages of large size containing text, images, sound, and video to be sent and to be received.

The multimedia messaging service is provided by a multimedia messaging server which enables multimedia messages to be sent and received from any device including means for communication with the multimedia messaging server and means for making up and reading multimedia messages, usually referred to as an MMS client module. This service can be deployed on a mobile network, e.g. GSM, GPRS, or UMTS, or on a fixed network whether wired or otherwise.

Furthermore, most mobile or fixed operators make a voice messaging service available to their subscribers. When a user having this service cannot be reached, for example because the user's terminal is off or outside the coverage of the network, or if the line is busy, or if it has been forwarded unconditionally to a voice messaging service, or if the user refuses to take the call, then the caller can record a voice message in the subscriber's voice in-box. Thereafter, the messaging service informs the user that a new message is available in the voice in-box.

Reception of a new message can be notified in various ways, in particular by way of text or by way of voice.

When notification is by way of text, it can be performed by sending an SMS message, or an electronic email message. SMS messages are received on the user's mobile or fixed station. Messages sent by email can be consulted from a computer or a personal digital assistant (PDA) via an Internet site, or indeed from a mobile terminal used in WAP mode.

The existence of a new message in an in-box can also be notified by a phone call or by sending a message to a fixed station, in which case the fixed station issues a specific tone or displays visual information in order to indicate that a voice message is present in the voice in-box.

Whatever the notification mode that is used, messages that have been deposited can be consulted either directly from the telephone having the voice box subscription, or else indirectly from any telephone.

However, no existing mode of notification makes it possible to include the voice message itself directly in a notification sent to the destination terminal. The various notification means presently in existence serve only to notify the existence of a message and do not enable that message to be listened to or read.

Consequently, after receiving the notification message indicating the presence of a new message in the voice box, the subscribing user must then call the voice messaging service is order to listen to that message. This procedure is not user-friendly, it takes up time, and it requires the user to know the number of the messaging service. Furthermore, this service is billed by certain operators.

In addition, existing modes of consultation do not enable the user to store the voice message locally in the user's telecommunications terminal, so as to be able to listen to it in deferred time or to transfer it to another user.

### OBJECTS AND SUMMARY OF THE INVENTION

An object of the present invention is to enable any user having a terminal that includes an MMS client to receive a message deposited in the user's messaging service directly on the terminal.

To do this, the invention provides a method of submitting to a telecommunications terminal a message deposited in an in-box of a messaging server, the method comprising the following steps:
transmitting the message placed in the destination user's in-box to a multimedia messaging server; and
transmitting a multimedia message containing at least the message deposited in the multimedia messaging server to the destination user's terminal.

The method further comprises the following steps:
using a processor unit of the messaging server to establish information relating to the deposited message and/or information relating to the in-box; and
introducing said information into the deposited message by means of the processor unit of the messaging server.

By means of this method, the subscriber has the voice or visible message that has been deposited in the messaging server made directly available on the user's own telecommunications terminal.

The invention simplifies the actions that a user needs to take in order to access messages, and improves the user-friendly nature of conventional messaging services.

In particular implementations, the method of submitting a message includes one or more of the following characteristics:
the messaging server is a voice messaging server, the deposited message comprising voice data;
the deposited message comprises image type data;
the deposited message also comprises text data;
the method includes a step of the processor unit of the messaging server introducing data of the image type as stored in a memory of the messaging server into the deposited message;
the method also includes a step of recording the deposited message in the in-box of the messaging server when the telecommunications terminal of the destination user cannot be reached;
the method also includes a step of recording the multimedia message in a memory of the multimedia messaging server;
the method also includes a step of recording the multimedia message in a memory of the telecommunications terminal of the destination user; and
the transmission of the deposited message to the multimedia messaging server further includes the following intermediate steps:
   transmitting the deposited message from the messaging server to a gateway server to convert the communications protocol of the deposited message into a protocol that is readable by the multimedia messaging server, e.g. a protocol of the SMTP type; and
   transmitting the converted message from the gateway server to the multimedia messaging server.

The present invention also provides a system of submitting a message that has been deposited in an in-box of a messaging server, the system comprising at least:
at the messaging server, an interface for communication with a multimedia messaging server enabling the deposited message to be transmitted to the multimedia messaging server;
at the telecommunications terminal of the destination user, a communications interface with the multimedia messaging server to receive the multimedia message containing the deposited message, and means for reading multimedia messages enabling the deposited message to be played back directly on the telecommunications terminal; and
a processor unit suitable for establishing information relating to the deposited message and/or information relating to the in-box, and for introducing said information into the deposited message.

In particular embodiments, the system for submitting a message includes one or more of the following characteristics:
the telecommunications terminal of the destination user also includes a memory suitable for storing multimedia messages;
the telecommunications network is a mobile telephone network and/or a fixed station network;
the communications interface of the messaging server is of the XML interface type, and the system includes a gateway server for converting the communications protocol into a protocol that is readable by the multimedia messaging server.

### BRIEF DESCRIPTION OF THE DRAWINGS

The invention will be better understood on reading the following description given by way of non-limiting example and with reference to the sole accompanying FIGURE which shows a system for submitting messages to the telecommunications terminal of a destination user.

### MORE DETAILED DESCRIPTION

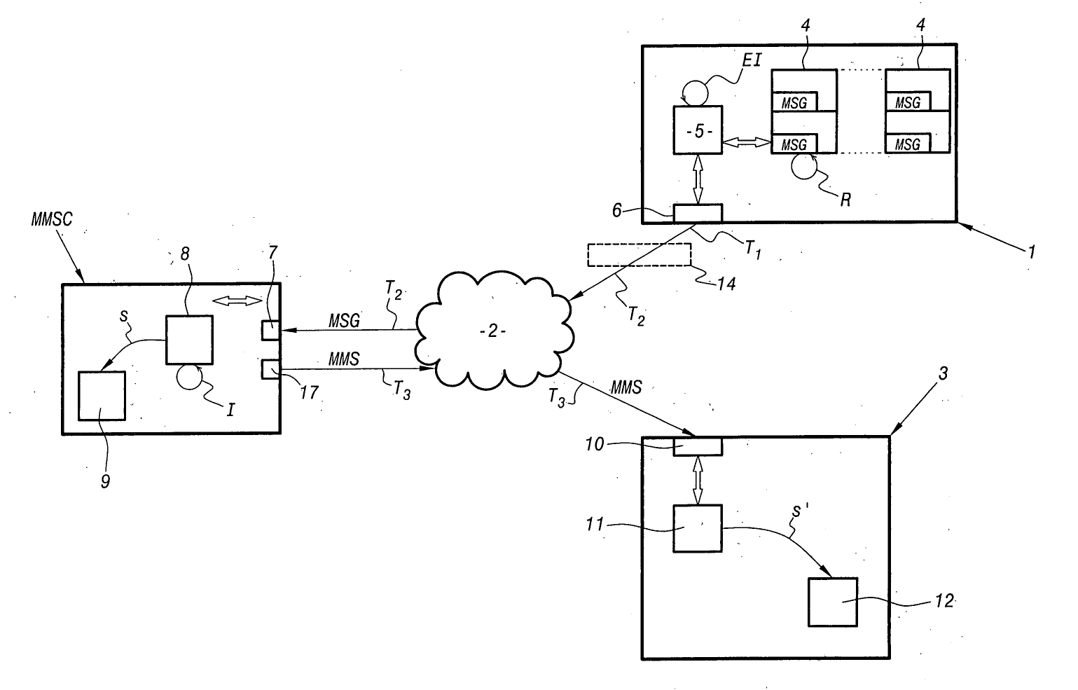

The message submission system shown in FIG. 1 comprises a messaging server 1 connected to a communications network 2 so as to be able to communicate with a multimedia messaging server MMSC and with a telecommunications terminal 3 of a user having a subscription with the messaging server 1.

The message submission system of the invention is described below in an application to a voice messaging server. Nevertheless, it could also be applied to a text or image messaging server. In which case, messages could be constituted, for example, by a weather map or a newspaper article.

The voice messaging server 1 shown in FIG. 1 comprises a set of message in boxes 4, a processing unit suitable for managing the messages (MSG) recorded in the in boxes 4, and a communications interface 6 with a multimedia messaging server MMSC.

Each in-box 4 is dedicated to a particular subscribing user and is identified by identification means such as, for example, the telephone number of the subscribing user.

The processor unit 5 of the messaging service 1 is suitable for managing the voice messages (MSG) recorded in the in-boxes 4.

In particular, the processor unit is suitable for performing two functions referred to respectively as “illustration” and “information”. These functions can be activated or deactivated on the command of the operator of the voice messaging service or of the subscribing user, e.g. by sending an MMS or an SMS message.

When the “illustration” function is activated and the user receives a voice message, the processor unit 5 of the voice messaging service is suitable for adding image data to the received voice message. This image data is stored in a memory (not shown) of the voice messaging server. Advantageously, this image data is constituted, for example, by the logo of the operator, by an advertising image, or by a photograph.

When the “information” function is activated, the processor unit 5 of the messaging server 1 analyzes the received message and establishes text information relating to the message and/or to other messages stored in the in-box. By way of example, the text information may comprise the telephone number of the sender, the date and time at which the message was received, the size of the received message, the number of messages stored in the in-box, or the percentage of non-allocated memory that remains available therein.

When both the “illustration” and the “information” functions are activated, the processor unit 5 of the voice messaging server 1 is adapted to put the voice message, the text data, and the image data into a single message.

In addition, the processor unit 5 is adapted to send a message containing the voice message to the communications terminal 3 of the subscribing user via a multimedia messaging server MMSC.

Thus, when the “illustration” and “information” functions are activated, the image data and the text information are sent to the multimedia messaging server MMSC together with the voice message.

Consequently, in the invention, the messaging server 1 is adapted to send the messages deposited in the in-box 4 of a subscribing user together with the image data and the text data associated with the voice message to a multimedia messaging server MMSC.

The communications interface 6 of the voice messaging server enables it to dialog with the multimedia server MMSC. Various types of interface can be used.

Thus, a first type of interfacing consists in using an email notification service that is already available in some fixed or mobile voice messaging services. In which case, an electronic email message is sent directly to an interface 7 of the multimedia server MMSC. This email contains as an attachment the voice message from the caller, optionally together with image data and text data including information relating to the message or to the in-box. This email notification service is adapted to dialog with an MM3 type interface of the multimedia messaging server MMSC. The MM3 interface is generally used between a multimedia messaging server and external messaging systems. It is not standardized, but implementations using the SMTP protocol are specified in the standards described in the document MMS 3GPP TS 23.140: “Appendix 1: example implementations of MMS architectures”.

Similarly, a second type of interfacing consists in using an XML library, likewise already available on some voice messaging services. Since XML libraries communicate using HTML language and HTTP protocol, the message MSG is initially sent to an intermediate gateway 14 for conversion into SMTP protocol, so as to make it readable by the MM3 type interface of the multimedia messaging server. Then, the message is sent T2 to the multimedia messaging server MMSC. The wealth of functions available in the XML library makes it possible to enhance the service given, in particular by making it possible to manage messages, e.g. by deleting a voice message immediately after it has been transferred to the multimedia server MMSC.

A third type of interfacing consists in using the MM7 type interface of the multimedia messaging server. This MM7 interface is conventionally used between a multimedia messaging server MMS and suppliers of value-added services. It is standardized and known as the SOAP protocol.

Conventionally, the multimedia server MMSC comprises a communications interface 7 for communication with the voice messaging server 1, a communications interface 17 for communication with the user's terminal, a processor unit 8 for processing messages, and data storage means 9.

The interface 7 for communication with the voice messaging server 1 can be constituted by an interface of the MM3 type using the SMTP protocol or an interface of the MM7 type using a SOAP protocol.

The communications interface 17 is an interface of the MM1 type adapted to communicated with an MMS client module 11 of a communications terminal.

The processor unit 8 is capable of receiving multimedia messages and of processing them so that they can be read by any terminal that includes an MMS client module.

The data storage means or memory 9 are adapted to store voice messages temporarily together with associated image and text data, if any, until they have been received by the telecommunications terminal 3 of the subscribing user.

In the invention, the multimedia messaging server MMSC is adapted to send a multimedia message MMS containing a voice message MSG together with image data and text data when these functions have been activated, to the telecommunications terminal 3 of the subscribing user.

Advantageously, the telecommunications terminal 3 of the subscribing user includes a communications interface 10 for communicating with the multimedia messaging server MMS, an MMS client module 11, and data storage means 12. Preferably, the communications interface 10 of the telecommunications terminal is of the MM1 interface type.

The MMS client module 11 is firstly means for communicating with the multimedia messaging server, and secondly means for preparing, reading, and presenting multimedia messages MMS.

The MMS client 11 of the communications terminal 3 is adapted to manage multimedia messages MMS. Thus, the user can decide to store them in the terminal, to play them back again, and to delete them, or even to transfer them to some other user.

The communications interfaces 6, 7, 10, and 17, the processor units 5 and 8, and also the MMS client module 11 can be implemented in hardware using a microcontroller or in software using a software medium or a programmed component executed by a microprocessor from a non-volatile memory.

The data storage means 12 is constituted by a non-volatile memory of the read-only memory (ROM), of the electrically-erasable programmable read-only memory (EEPROM) type, or the equivalent. Its capacity may typically be about 500 kilobytes (kB) or more, thus enabling multimedia messages to be stored.

The various steps of the method of submitting a message deposited in an in-box to a destination terminal are described below.

When a destination subscriber cannot be reached, a message MSG can be recorded in an in-box 4 belonging to the subscribing user during a step R.

When a voice message has been recorded, a processor unit 5 of the voice messaging server 1 acts during a step T1, T2 to send the deposited message MSG to the multimedia server MMSC via the communications interfaces 6, 7 and the network 2.

If the “information” function is activated at the voice messaging server, then the processor unit 5 of said server analyzes the deposited voice message and establishes text data containing information about the message, and possibly also about other messages stored in the in-box 4 of the destination user.

During a step E1, the processor unit 5 adds the text data that it has established to the voice message.

If the “illustration” function has been activated at the voice messaging server, then the processor unit 5 acts during the step E1 to include an illustration in the message it sends, such that the message sent to the multimedia messaging server MMSC includes image data and voice data.

If both the “information” and the “illustration” functions have both been activated, then during steps T1, T2, the processor unit 5 sends a message containing voice data, text data, and image data to the multimedia server MMSC via the communications interfaces 6, 7 and the network 2.

Thereafter, in a step I, the processor unit 8 of the multimedia messaging server MMSC processes the message sent by the voice messaging server 1.

The message sent by the voice messaging server is stored temporarily during a step S in a memory 9 of the multimedia messaging server MMSC.

In a step T3 of the message submission method, the multimedia message MMS is sent to the telecommunications terminal 3 of the destination user. As soon as the multimedia message has been successfully received by the telecommunications terminal 3, the multimedia messaging server MMSC deletes it from its own memory.

Thus, the invention enables the destination user to receive the voice message MSG that the caller has deposited in the in-box of the user's voice messaging server directly in the user's own telecommunications terminal 3, and when the “information” and “illustration” functions have been activated, the user also receives text data and image data.

Furthermore, it is preferable for the voice messaging server 1 not to send any other notification of the presence of a message in the in-box 4 as would usually be done, so as to avoid the user being notified twice about reception of the same voice message.

In a preferred implementation of the invention, the subscribing user can act on the voice messaging server to activate or deactivating the sending of new voice messages by sending multimedia messages or by SMS. Access to management of activation and deactivation can be performed as follows:
by a voice call from the line owning the voice box;
by sending an SMS or an MMS from the line owning the box voice;
by web or WAP access enabling the user to modify notification options; or by using two USSD codes dedicated to activating and deactivating said notification.

Advantageously, the voice message MSG recorded during step R in the in-box 4 of the destination user can be stored on the messaging server 1 after it has been transferred to the multimedia messaging server center MMSC. In which case, it is still possible to consult the message on the voice messaging server 1. Thus, if the telecommunications terminal 3 cannot be reached, the subscribing user can still consult the message MSG deposited in the in-box.

Advantageously, when the user's communications terminal receives the multimedia message, the MMS client module 11 can record it in the memory 12 of the user's communications terminal during a step S′.

Advantageously, this service of submitting messages via a multimedia messaging server can be offered by an operator to all subscribers having a terminal that includes an MMS client module.

Advantageously, the invention can be applied to a fixed telephone network or to a mobile telephone network.

1. A method of submitting a message (MSG) to a telecommunications terminal (3) of a destination user, which message has been deposited in an in-box (4) of a messaging server (1) by a sender user, submission taking place via a telecommunications network (2) and comprising the following steps:
transmitting (T1, T2) the message (MSG) deposited in the destination user's in-box (4) in the messaging server (1) to a multimedia messaging server (MMSC); and
transmitting (T3) a multimedia message (MMS) from the multimedia messaging server (MMSC) to the terminal (3) of said destination user, the multimedia message containing at least said deposited message (MSG), thus enabling said destination user to have the deposited message directly available locally on the user's communications terminal (3);
the method further comprising the following steps:
using a processor unit (5) of the messaging server (1) to establish information relating to the deposited message (MSG) and/or information relating to the in-box (4); and
introducing (EI) said information into the deposited message (MSG) by means of the processor unit (5) of the messaging server (1).

2. A message submission method according to claim 1, wherein said messaging server (1) is a voice messaging server, said deposited message (MSG) comprising voice data.

3. A message submission method according to claim 1, wherein the deposited message (MSG) comprises image type data.

4. A message submission method according to claim 2, also comprising text data.

5. A message submission method according to claim 2, including a step of the processor unit (5) of the messaging server (1) introducing (EI) data of the image type as stored in a memory of the messaging server (1) into the deposited message (MSG).

6. A message submission method according to claim 1, also including a step (R) of recording the deposited message (MSG) in the in-box (4) of the messaging server (1) when the telecommunications terminal (3) of the destination user cannot be reached.

7. A message submission method according to claim 1, also including a step (S) of recording the multimedia message (MMS) in a memory (9) of the multimedia messaging server (MMSC).

8. A message submission method according to claim 1, also including a step (S′) of recording the multimedia message (MMS) in a memory (12) of the telecommunications terminal (3) of the destination user.

9. A message submission method according to claim 1, wherein the transmission of the deposited message (MSG) to the multimedia messaging server (MMSC) further includes the following intermediate steps:
transmitting (T1) the deposited message (MSG) from the messaging server (1) to a gateway server (14) to convert the communications protocol of the deposited message into a protocol that is readable by the multimedia messaging server (MMSC), e.g. a protocol of the SMTP type; and
transmitting (T2) the converted message from the gateway server (14) to the multimedia messaging server (MMSC).

10. A system for submitting a message that has been deposited in an in-box (4) of a messaging server (1) by a sender user for a destination user having a telecommunications terminal (3), submission being via a telecommunications network (2), and the system comprising at least:
at said messaging server (1),
a communications interface (6) for communication with a multimedia messaging server (MMSC) enabling the deposited message (MSG) to be transmitted to said multimedia messaging server (MMSC); and
at the telecommunications terminal (3) of the destination user, both
a communications interface (10) for communicating with said multimedia messaging server (MMSC) to receive said multimedia message (MMS) containing said deposited message (MSG), and
a multimedia client module (11) for multimedia messages (MMS) enabling said deposited message (MSG) to be played back directly by said telecommunications terminal (3);
wherein said messaging server (1) includes a processor unit (5) suitable for establishing information relating to the deposited message (MSG) and/or information relating to the in-box (4), and for introducing said information into the deposited message (MSG).

11. A message submission system according to claim 10, wherein the telecommunications terminal (3) of the destination user also includes a memory (12) suitable for storing multimedia messages (MMS).

12. A message submission system according to claim 10, wherein the telecommunications network (2) is a mobile telephone network and/or a fixed station network.

13. A message submission system according to claim 10, wherein the communications interface of the messaging server (1) is of the XML interface type, and wherein the system includes a gateway server (14) for converting the communications protocol into a protocol that is readable by the multimedia messaging server (MMSC).
